(19) United States
(12) Patent Application Publication
(10) Pub. No.: US 2026/0193456 A1
(43) Pub. Date: Jul. 9, 2026

(54) ALTERNATIVE METHOD TO CONTROL RHEOLOGY OF POLYPROPYLENE OR RECYCLED POLYPROPYLENE

(71) Applicant: Fina Technology, Inc., Houston, TX (US)

(72) Inventors: Peng Li, Sugar Land, TX (US); Fengkui Li, Houston, TX (US); Joachim Azzi, Houston, TX (US); Fabrice Dehais, Houston, TX (US); Xiuhua Cui, Pearland, TX (US); Jared Youts, Houston, TX (US)

(73) Assignee: Fina Technology, Inc., Houston, TX (US)

(21) Appl. No.: 19/441,645

(22) Filed: Jan. 6, 2026

Related U.S. Application Data
(60) Provisional application No. 63/742,757, filed on Jan. 7, 2025.

(51) Int. Cl. C08L 23/12; C08F 110/06; C08K 5/01

(52) U.S. Cl. CPC C08L 23/12; C08F 110/06; C08K 5/01; C08K 2201/002; C08L 2207/20

(57) ABSTRACT

A polypropylene composition containing a polypropylene base resin, and a polyolefin wax. The polypropylene composition may comprise the polyolefin wax in an amount ranging from greater than or equal to about 1 weight percent (wt %) to less than or equal to about 20 wt %, based on a total weight of the polypropylene composition.

### CROSS REFERENCE TO RELATED APPLICATIONS

This application claims priority to U.S. provisional patent application Ser. No. 63/742,757 filed Jan. 7, 2025, and entitled “Alternative Method to Control Reheology of Polypropylene or Recycled Polypropylene,” which is hereby incorporated herein by reference in its entirety for all purposes not contrary to this disclosure.

### STATEMENT REGARDING FEDERALLY SPONSORED RESEARCH OR DEVELOPMENT

Not applicable.

### TECHNICAL FIELD

The disclosure relates generally to polypropylene. More particularly, the disclosure relates to polypropylene compositions comprising polyolefin wax. Still more particularly, the present disclosure relates to polypropylene comprising polyolefin wax and having desirable mechanical properties and low odor.

### BACKGROUND

High flowability, for example, as may be associated with a high melt flow rate (MFR), can be desirable for many polypropylene applications due to the melt processability of high MFR polypropylene. However, due to limitations of both catalysts and production facilities, high flowability is not easily and economically achieved during polymerization in reactors. Therefore, control rheology (CR) or vis-breaking with peroxide has been used to achieve high MFR via post-reactor processing. Vis-breaking refers to a process of peroxide-induced polypropylene degradation. The resulting products of vis-breaking typically have higher MFR and narrow MWD; however, a disadvantage of peroxide visbreaking is that peroxide decomposition byproducts can cause odor issues that are not acceptable for many applications, such as, food packaging. By way of example, the decomposition of some organic peroxides may result in acetone and t-butanol byproducts, and the decomposition of other peroxides may produce acetic acid, ethyl acetate, methyl ethyl ketone (MEK), etc. Accordingly, an alternative approach that overcomes the potential odor issue for high flowability polypropylene resins would be beneficial.

### SUMMARY

These and other needs in the art are addressed in one embodiment by a polypropylene composition comprising: a polypropylene base resin; and a polyolefin wax, wherein the polypropylene composition comprises the polyolefin wax in an amount ranging from greater than or equal to about 1 weight percent (wt %) to less than or equal to about 20 wt %, based on a total weight of the polypropylene composition.

These and other needs in the art are addressed in another embodiment by a method of increasing a flowability of a polypropylene base resin, the method comprising: combining the polypropylene base resin with a polyolefin wax to provide a polypropylene composition having the increased flowability, as determined by an increased melt flow rate, determined according to ASTM D1238, and/or a decreased viscosity, determined according to ASTM D7042, relative to that of the polypropylene base resin.

These and other needs in the art are addressed in another embodiment by a hybrid composition comprising: a polyolefin wax; virgin polypropylene; and recycled polypropylene, wherein the hybrid composition comprises the virgin polypropylene in an amount ranging from greater than or equal to about 50 weight percent (wt %) to less than or equal to about 90 wt %, and the recycled polypropylene in an amount ranging from greater than or equal to about 10 wt % to less than or equal to about 50 wt %, based on a total weight of the virgin and recycled polypropylene, and wherein the hybrid composition has an improved flowability as measured by a decreased viscosity, determined according to ASTM D7042, and/or an increased melt flow rate, as determined according to ASTM D1238, relative to a same composition absent the polyolefin wax.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF DRAWINGS

For a detailed description of various exemplary embodiments, reference will now be made to the accompanying drawings in which:

FIG. 1 is a bar graph depicting the MFR of CC1, CC2, IC1, and IC2 of Example 1, as determined according to ASTM D1238;

FIG. 2 is a bar graph depicting the Flexural Modulus (kpsi) of CC1, CC2, IC1, and IC2 of Example 1, as determined according to ASTM D790;

FIG. 3 is a bar graph depicting the Izod Impact (ft-lb/in) of CC1, CC2, IC1, and IC2 of Example 1, as determined according to ASTM D256A;

FIG. 4 is a bar graph depicting the Tensile Yield Strength (psi) of CC1, CC2, IC1, and IC2 of Example 1, as determined according to ASTM D638;

FIG. 5 is a bar graph depicting the Tensile Modulus (kpsi) of CC1, CC2, IC1, and IC2 of Example 1, as determined according to ASTM D638;

FIG. 6 is a bar graph depicting the MFR of CC3, IC3, and IC4 of Example 2, as determined according to ASTM D1238;

FIG. 7 is a bar graph depicting the Flexural Modulus (kpsi) of CC3, IC3, and IC4 of Example 2, as determined according to ASTM D790;

FIG. 8 is a bar graph depicting the Izod Impact (ft-lb/in) of CC3, IC3, and IC4 of Example 2, as determined according to ASTM D256A;

FIG. 9 is a bar graph depicting the Tensile Yield Strength (psi) and Tensile Yield Elongation (%) of CC3, IC3, and IC4 of Example 2, as determined according to ASTM D638; and

FIG. 10 is a bar graph depicting the Tensile Modulus (kpsi) of CC3, IC3, and IC4 of Example 2, as determined according to ASTM D638.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

Unless the context dictates the contrary, all ranges set forth herein should be interpreted as being inclusive of their endpoints, and open-ended ranges should be interpreted to include only commercially practical values. In addition, with respect to all ranges disclosed herein, such ranges are intended to include any combination of the mentioned upper and lower limits even if the particular combination is not specifically listed. All lists of values should be considered as inclusive of intermediate values unless the context indicates the contrary. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.).

In the following discussion and in the claims, the terms “including” and “comprising” are used in an open-ended fashion, and thus should be interpreted to mean “including, but not limited to . . . ” As used herein, the phrases “consist(s) of” and “consisting of” are used to refer to exclusive components of a composition, meaning only those expressly recited components are included in the composition; whereas the phrases “consist(s) essentially of” and “consisting essentially of” are used to refer to the primary components of a composition, meaning that only small or trace amounts of components other than the expressly recited components (e.g., impurities, byproducts, etc.) may be included in the composition. For example, a composition consisting of X and Y refers to a composition that only includes X and Y, and thus, does not include any other components; and a composition consisting essentially of X and Y refers to a composition that primarily comprises X and Y, but may include small or trace amounts of components other than X and Y. In embodiments described herein, any such small or trace amounts of components other than those expressly recited following the phrase “consist(s) essentially of” or “consisting essentially of” preferably represent less than 5.0 wt % of the composition, more preferably less than 4.0 wt % of the composition, even more preferably less than 3.0 wt % of the composition, and still more preferably less than 1.0 wt % of the composition. Use of broader terms such as comprises, includes, having, etc. should be understood to provide support for narrower terms such as consisting of, consisting essentially of, comprised substantially of, etc. Use of the term “optionally” with respect to any element of a claim is intended to mean that the subject element is required, or alternatively, is not required. Both alternatives are intended to be within the scope of the claim. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

In some embodiments disclosed herein are polypropylene compositions generally comprising a polypropylene base resin and a polyolefin wax. The polypropylene composition may comprise the polyolefin was in an amount ranging from greater than or equal to about 1 wt % to less than or equal to about 20 wt %, additionally or alternatively, from greater than or equal to about 5 wt % to about 15 wt % or, additionally or alternatively, from greater than or equal to about 10 wt % to less than or equal to about 15 wt %, based on a total weight of the polypropylene composition. A weight ratio of the polypropylene base resin to the polyolefin wax can be in a range of from about 1:1 to about 20:1, additionally or alternatively, from about 5:1 to less than about 15:1 or, additionally or alternatively, from about 10:1 to about 15:1. In some embodiments, the polypropylene compositions disclosed herein may result from the methods as also disclosed herein.

For example, also disclosed herein are methods for reducing the viscosity of a polypropylene base resin without the necessity of conventional (e.g., peroxide visbreaking) processes noted above. Specifically, in various embodiments, the addition of an amount polyolefin wax may be effective to reduce the melt viscosity of the polypropylene base resin and/or to increase the MFR of the polypropylene base resin.

Polyolefin waxes suitable for use in the polypropylene compositions of this disclosure can originate from petroleum, recycled resources, or even natural renewable resources. The peroxide-free formulations described herein and produced via the disclosed method can exhibit comparable thermal and mechanical properties to conventional (e.g., peroxide vis-broken) polypropylene resins with similar MFRs. In some embodiments, a major advantage of the peroxide-free formulations of this disclosure can be the absence of undesired decomposition byproducts (e.g., peroxide), which can result in undesirable characteristics of the polypropylene (e.g., odor). As such, the disclosed polypropylene compositions may be more suitable for applications in many packaging applications (e.g., direct-food contact). In some embodiments, the disclosed methods can be particularly useful in designing the MFRs of hybrid recycled polypropylene formulations, where recycled polypropylene sources (and thus compositions) can be varied.

In some embodiments, the polypropylene base resin can comprise virgin polypropylene, recycled polypropylene, or a combination thereof. In some embodiments, the polypropylene base resin is a hybrid resin comprising virgin polypropylene and recycled polypropylene. In various embodiments, the hybrid resin comprising virgin polypropylene and recycled polypropylene can comprise the virgin polypropylene in an amount ranging from greater than or equal to about 1 wt % to less than or equal to about 90 wt % of the virgin polypropylene and from greater than or equal to about 90 wt % to less than or equal to about 1 wt %, based on a total weight of the hybrid resin comprising virgin polypropylene and recycled polypropylene. A virgin polypropylene includes a polypropylene that has not been previously utilized in a product; a recycled polypropylene includes a polypropylene that has previously been utilized in a product; a hybrid recycled polypropylene includes a polypropylene that includes virgin and recycled polypropylene. The polypropylene base resin may comprise polypropylene in an amount of greater than or equal to about 50, 60, or 70 wt % polypropylene to less than or equal to about 80, 90, 95, or 99 wt % polypropylene.

In various embodiments, the polypropylene base resin can comprise a homopolymer, a copolymer, an impact copolymer (also referred to as a heterophasic copolymer), or a combination thereof. The polypropylene base resin can comprise a Ziegler-Natta-catalyzed polypropylene, a metallocene-catalyzed polypropylene, or a combination thereof. The polypropylene base resin can comprise a reactor powder polypropylene.

In some embodiments, the polypropylene base resin can comprise a homopolymer. In some embodiments, the homopolymer can further comprise up to 5% of another alpha-olefin, examples of which include, but not limited to, C2-C8 alpha-olefins, such as ethylene and 1-butene. The polypropylene homopolymer can be atactic polypropylene, isotactic polypropylene, hemi-isotactic polypropylene, syndiotactic polypropylene, or a combination thereof. A polymer is “atactic” when its pendant groups are arranged in a random fashion on both sides of the chain of the polymer. A polymer is “isotactic” when all of its pendant groups are arranged on the same side of the chain. A polymer is “syndiotactic” when its pendant groups alternate on opposite sides of the chain. A polymer is hemi-isotactic polymer when every other repeat unit has a random substituent.

In some embodiments, the polypropylene base resin can comprise an impact copolymer. Impact copolymer is a type of polypropylene (PP) resin that is modified with ethylene-propylene rubber to, for example, improve its toughness and impact strength. Impact copolymer can be produced in two or more reactors, where the first reactor polymerizes the polypropylene homopolymer matrix and the second reactor polymerizes the rubber phase that is dispersed in the matrix. Impact copolymer can also be referred to as heterophasic copolymer. In other embodiments, the polypropylene base resin comprises a polypropylene heterophasic copolymer in which a polypropylene homopolymer phase or component is joined to a copolymer phase or component. The polypropylene base resin can comprise ethylene in an amount ranging from greater or equal to than 6.5 wt % to less than or equal to 20 wt % by total weight of the polypropylene base resin, additionally or alternatively, from greater than or equal to 8.5 wt % to less than or equal to 18 wt % or, additionally or alternatively, from greater than or equal to 9.5 wt % to less than or equal to 16%. In some embodiments, the copolymer phase of a polypropylene base resin can comprise a random copolymer of propylene and ethylene, also referred to as an ethylene/propylene rubber (EPR). Polypropylene impact copolymers may exhibit distinct homopolymer phases that are interrupted by short sequences or blocks having a random arrangement of ethylene and propylene. In comparison to random copolymers, the block segments comprising the EPR may have certain polymeric characteristics (e.g., intrinsic viscosity) that differ from that of the copolymer as a whole. Without wishing to be limited by theory, the EPR portion of the impact copolymer may exhibit rubbery characteristics which, when incorporated within the matrix of the homopolymer component, can function to provide increased impact strength to the polypropylene heterophasic copolymer. In embodiments, the EPR portion of the polypropylene heterophasic copolymer comprises greater than or equal to 14 wt % of the polypropylene heterophasic copolymer, additionally or alternatively, greater than or equal to 18 wt % of the polypropylene heterophasic copolymer, additionally or alternatively, ranging from greater than or equal to 14 wt % to less than or equal to 18 wt % of the polypropylene heterophasic copolymer.

In embodiments, the amount of ethylene present in the EPR portion of the polypropylene heterophasic copolymer can range from greater than or equal to 38 wt % to less than or equal to 60 wt %, additionally or alternatively, from greater than or equal to 40 wt % to less than or equal to 45 wt % based on the total weight of the EPR portion. In an embodiment, the polypropylene heterophasic copolymer may exhibit a MFR of from greater than or equal to 1 decigrams per minute (dg/min) to 100 dg/min, additionally or alternatively, greater than or equal to from 1.5 dg/min. to less than or equal to 50 dg/min.

In embodiments, polypropylene base resin comprises a polypropylene homopolymer. The polypropylene homopolymer can have a density of from greater than or equal to 0.895 g/cm³ to less than or equal to 0.920 g/cm³, additionally or alternatively, from greater than or equal to 0.900 g/cm³ to less than or equal to 0.915 g/cm³ or, additionally or alternatively, from greater than or equal to 0.905 g/cm³ to less than or equal to 0.915 g/cm³, as determined in accordance with ASTM D1505. In embodiments of the present disclosure, the propylene homopolymer may exhibit a MFR ranging from greater than or equal to 10 dg/min to less than or equal to 100 dg/min, additionally or alternatively, from greater than or equal to 20 dg/min to less than or equal to 90 dg/min or, additionally or alternatively, ranging from greater than or equal to 30 dg/min to less than or equal to 70 dg/min as measured by ASTM D1238. In some embodiments, the MFR of the propylene homopolymer is less than 100 dg/min.

In embodiments, the polypropylene composition (or hybrid polypropylene composition described below) can comprise the polypropylene base resin in an amount ranging from about greater than or equal to about 55 wt % to less than or equal to about 90 wt %, additionally or alternatively, from greater than or equal to about 60 wt % to less than or equal to about 85 wt % or, additionally or alternatively, from greater than or equal to about 70 wt % to less than or equal to about 80 wt %, based on a total weight of the propylene (hybrid) composition.

The polypropylene base resin may exhibit a MFR, according to ASTM D1238 in a range of from greater than or equal to about 0.5 dg/min to less than or equal to about 200 dg/min, from greater than or equal to about 20 dg/min to less than or equal to about 150 dg/min, or from greater than or equal to about 50 dg/min to less than or equal to about 100 dg/min. The polypropylene base resin can be a reactor grade polypropylene or a vis-broken grade polypropylene.

As utilized herein, a “polyolefin wax” refers to a polyolefin that is a solid at room temperature, for example, 68° F. (20° C.), and may include low-molecular-weight polymers or oligomers, or their blends, that exhibit wax-like characteristics, such as low viscosity and high melt flow rate. Polyolefin waxes may be produced through polymerization processes using either Ziegler-Natta or metallocene catalysts. In various embodiments, the polyolefin wax can comprise a polypropylene wax, a polyethylene wax, a copolymer wax (e.g., a polypropylene/polyethylene copolymer wax), or a combination thereof. In some embodiments, the polyolefin wax is a product of, for example, is produced from, a petroleum-based, recycled resource (e.g., recycled plastics), a renewable resource(s), or a combination thereof. The renewable resource can comprise a hydrogenated vegetable oil wax, or a combination thereof, for example, which may be used to produce a polyethylene wax (e.g., available from Braskem).

In various embodiments, the polyolefin wax may exhibit a viscosity in a range of from greater than or equal to about 500 to less than or equal to about 50,000 MPa·s, additionally or alternatively, from greater than or equal to about 1000 to less than or equal to about 20000 MPa·s or, additionally or alternatively, from about 1000 to less than or equal to about 3000 MPa·s, as measured according to ASTM D 7042. The polyolefin wax can have a weight average molecular weight (Mw) in a range of from greater than or equal to about 10,000 to less than or equal to about 100,000 g/mol, additionally or alternatively, from greater than or equal to about 15,000 to less than or equal to about 50,000 g/mol or, additionally or alternatively, from greater than or equal to about 20,000 to less than or equal to about 30,000 g/mol.

In some embodiments, the polyolefin wax can comprise polypropylene wax, polyethylene wax, or a combination there. For example, in some more particular embodiments, the polyolefin wax comprises a polypropylene wax. The polypropylene wax can have a Mw in a range of from greater than or equal to about 10,000 to less than or equal to about 100,000 g/mol, additionally or alternatively, from greater than or equal to about 15,000 to less than or equal to about 50,000 g/mol or, additionally or alternatively, from greater than or equal to about 20,000 to less than or equal to about 30,000 g/mol. Also, for example, in some embodiments, the polyolefin comprises a polyethylene wax. The polyethylene wax can have a Mw in a range of from greater than or equal to about 10,000 to less than or equal to about 100,000 g/mol, additionally or alternatively, from greater than or equal to about 15,000 to about 50,000 g/mol or, additionally or alternatively, from greater than or equal to about 20,000 to less than or equal to about 30,000 g/mol.

In some embodiments, the polyolefin wax can comprise a metallocene-catalyzed polyolefin (e.g., polypropylene) wax. In some more particular embodiments, the polyolefin wax comprises a single site metallocene-catalyzed polyolefin wax (e.g., LICOCENE® 7502, a medium viscous metallocene catalyzed polypropylene wax available from Clariant). The polyolefin wax can exhibit at least (e.g., greater than or equal to) about 10, 20, or 30 percent crystallinity, as determined, for example, by Differential Scanning calorimetry (DSC). In embodiments, the polyolefin wax has a melt temperature (T_{MELT}) of greater than or equal to about 100° C., 110° C., 120° C., 130° C., or 140° C.

In some embodiments, the polypropylene composition can have a MFR, according to ASTM D1238, in a range of greater than or equal to from about 10 to less than or equal to about 200 dg/min, from greater than or equal to about 20 dg/min to less than or equal to about 150 dg/min, or from greater than or equal to about 50 dg/min to less than or equal to about 100 dg/min. In some embodiments, the polypropylene composition has a MFR, as determined according to ASTM D1238. For example, the polypropylene composition can have MFR that is at least 150% greater than the MFR of the same polypropylene composition absent the polyolefin wax, additionally or alternatively, at least 100% or, additionally or alternatively, at least 50% greater, as determined according to ASTM D1238.

Additionally or alternatively, in some embodiments the polypropylene composition exhibits a flexural modulus that is within 50%, 40%, 30%, 20%, 15%, or 10% of the flexural modulus of the same composition absent the polyolefin wax, as measured according to ASTM D790. Additionally or alternatively, in some embodiments the polypropylene composition exhibits an Izod impact strength that is within 50%, 40%, 30%, 20%, 15%, or 10% of an Izod impact strength of the same composition absent the polyolefin wax, as measured according to ASTM D256A. Additionally or alternatively, in some embodiments the polypropylene composition exhibits a tensile yield strength, that is within 50%, 40%, 30%, 20%, 15%, or 10% percent of an tensile yield strength of the same composition absent the polyolefin wax, as measured according to ASTM D638. Additionally or alternatively, in some embodiments the polypropylene composition exhibits a tensile modulus that is within 50%, 40%, 30%, 20%, 15%, or 10% percent of a tensile modulus of the same composition absent the polyolefin wax, as measured according to ASTM D638.

In some embodiments, the polypropylene composition may be characterized not having an odor and/or as having relatively little odor. For example, the polypropylene composition does not comprise and/or comprises only trace amounts of byproducts such as acetone, t-butanol, acetic acid, ethyl acetate, MEK, and/or other byproducts that provide an odor to the polypropylene composition. Gas Chromatography-Mass Spectrometry (GC-MS) can be utilized, for example, to characterize amounts of volatile organic compounds (VOCs) related to odor.

Also disclosed herein is a method of increasing a flowability (e.g., controlling rheology, viscosity, or MFR) of a polypropylene base resin. The method can comprise: combining the polypropylene base resin with a polyolefin wax to provide a polypropylene composition having the increased flowability (e.g., an increased MFR, determined according to ASTM D1238, and/or a decreased viscosity, determined according to ASTM D7042) relative to that of the polypropylene base resin. Combining can comprise extruding the polypropylene base resin with (e.g., granules of) the polyolefin wax to provide the polypropylene composition. In some embodiments, the method does not include (e.g., conventional peroxide) vis-breaking.

The polypropylene base resin can be as described above. For example, in embodiments, the polypropylene base resin utilized in the method can comprise virgin polypropylene, recycled polypropylene, or a combination thereof. The polypropylene base resin can comprise a hybrid resin comprising virgin polypropylene and recycled polypropylene. In various embodiments, the hybrid resin comprising virgin polypropylene and recycled polypropylene can comprise the virgin polypropylene in an amount ranging from greater than or equal to about 10 wt % to less than or equal to about 90 wt % of the virgin polypropylene and from greater than or equal to about 10 wt % to less than or equal to about 90 wt % of the recycled polypropylene, based on a total weight of the hybrid resin comprising virgin polypropylene and recycled polypropylene.

In various embodiments, the polypropylene base resin utilized in the method can comprise a homopolymer, a copolymer, an impact copolymer (also referred to as a heterophasic copolymer), or a combination thereof. The polypropylene base resin can comprise a Ziegler-Natta-catalyzed polypropylene, a metallocene-catalyzed polypropylene, or a combination thereof. The polypropylene base resin can comprise a reactor powder polypropylene.

In some embodiments, the polypropylene base resin utilized in the method can comprise a homopolymer. In some embodiments, the homopolymer can further comprise up to 5% of another alpha-olefin, examples of which include, but not limited to, C2-C8 alpha-olefins, such as ethylene and 1-butene. The polypropylene homopolymer can be atactic polypropylene, isotactic polypropylene, hemi-isotactic polypropylene, syndiotactic polypropylene, or a combination thereof.

In some embodiments, the polypropylene base resin utilized in the method can comprise an impact copolymer, as described hereinabove. In embodiments, the polypropylene base resin comprises a polypropylene heterophasic copolymer in which a polypropylene homopolymer phase or component is joined to a copolymer phase or component. The polypropylene base resin can comprise ethylene in an amount ranging from greater or equal to than 6.5 wt % to less than or equal to 20 wt % by total weight of the polypropylene base resin, additionally or alternatively, from greater than or equal to 8.5 wt % to less than or equal to 18 wt % or, additionally or alternatively, from greater than or equal to 9.5 wt % to less than or equal to 16%. In some embodiments, the copolymer phase of a polypropylene base resin can comprise a random copolymer of propylene and ethylene, or EPR. In embodiments, the EPR portion of the polypropylene heterophasic copolymer comprises greater than or equal to 14 wt % of the polypropylene heterophasic copolymer, additionally or alternatively, greater than or equal to 18 wt % of the polypropylene heterophasic copolymer, additionally or alternatively, ranging from greater than or equal to 14 wt % to less than or equal to 18 wt % of the polypropylene heterophasic copolymer.

The amount of ethylene present in the EPR portion of the polypropylene heterophasic copolymer can range from greater than or equal to 38 wt % to less than or equal to 60 wt %, additionally or alternatively, from greater than or equal to 40 wt % to less than or equal to 45 wt % based on the total weight of the EPR portion. In an embodiment, the polypropylene heterophasic copolymer may exhibit a MFR of from greater than or equal to 1 dg/min to 100 dg/min, additionally or alternatively, greater than or equal to from 1.5 dg/min. to less than or equal to 50 dg/min.

In embodiments, polypropylene base resin utilized in the method comprises a polypropylene homopolymer. The polypropylene homopolymer can have a density of from greater than or equal to 0.895 g/cm³ to less than or equal to 0.920 g/cm³, additionally or alternatively, from greater than or equal to 0.900 g/cm³ to less than or equal to 0.915 g/cm³ or, additionally or alternatively, from greater than or equal to 0.905 g/cm³ to less than or equal to 0.915 g/cm³, as determined in accordance with ASTM D1505. In embodiments of the present disclosure, the propylene homopolymer may exhibit a MFR ranging from greater than or equal to 10 dg/min to less than or equal to 100 dg/min, additionally or alternatively, from greater than or equal to 20 dg/min to less than or equal to 90 dg/min or, additionally or alternatively, ranging from greater than or equal to 30 dg/min to less than or equal to 70 dg/min as measured by ASTM D1238. In some embodiments, the MFR of the propylene homopolymer is less than 100 dg/min.

In embodiments, the polypropylene composition (or hybrid polypropylene composition described below) utilized in the method can comprise the polypropylene base resin in an amount ranging from about greater than or equal to about 55 wt % to less than or equal to about 90 wt %, additionally or alternatively, from greater than or equal to about 60 wt % to less than or equal to about 85 wt % or, additionally or alternatively, from greater than or equal to about 70 wt % to less than or equal to about 80 wt %, based on a total weight of the propylene (hybrid) composition.

The polypropylene base resin may exhibit a MFR, according to ASTM D1238 in a range of from greater than or equal to about 0.5 dg/min to less than or equal to about 200 dg/min, from greater than or equal to about 20 dg/min to less than or equal to about 150 dg/min, or from greater than or equal to about 50 dg/min to less than or equal to about 100 dg/min. The polypropylene base resin can be a reactor grade polypropylene or a vis-broken grade polypropylene.

The polyolefin wax utilized in the method can be as described hereinabove. For example, in embodiments, the polyolefin wax can comprise a polypropylene wax, a polyethylene wax, a copolymer wax (e.g., a polypropylene/polyethylene copolymer wax), or a combination thereof. In some embodiments, the polyolefin wax is a product of, for example, is produced from, a petroleum-based, recycled resource (e.g., recycled plastics), a renewable resource(s), or a combination thereof. The renewable resource can comprise a hydrogenated vegetable oil wax, or a combination thereof, for example, which may be used to produce a polyethylene wax (e.g., available from Braskem).

In various embodiments, the polyolefin wax utilized in the method may exhibit a viscosity in a range of from greater than or equal to about 500 to less than or equal to about 50,000 MPa·s, additionally or alternatively, from greater than or equal to about 1000 to less than or equal to about 20000 MPa·s or, additionally or alternatively, from about 1000 to less than or equal to about 3000 MPa·s, as measured according to ASTM D 7042. The polyolefin wax can have a weight average molecular weight (Mw) in a range of from greater than or equal to about 10,000 to less than or equal to about 100,000 g/mol, additionally or alternatively, from greater than or equal to about 15,000 to less than or equal to about 50,000 g/mol or, additionally or alternatively, from greater than or equal to about 20,000 to less than or equal to about 30,000 g/mol.

In some embodiments, the polyolefin wax utilized in the method can comprise polypropylene wax, polyethylene wax, or a combination there. For example, in some more particular embodiments, the polyolefin wax comprises a polypropylene wax. The polypropylene wax can have a Mw in a range of from greater than or equal to about 10,000 to less than or equal to about 100,000 g/mol, additionally or alternatively, from greater than or equal to about 15,000 to less than or equal to about 50,000 g/mol or, additionally or alternatively, from greater than or equal to about 20,000 to less than or equal to about 30,000 g/mol. Also, for example, in some embodiments, the polyolefin comprises a polyethylene wax. The polyethylene wax can have a Mw in a range of from greater than or equal to about 10,000 to less than or equal to about 100,000 g/mol, additionally or alternatively, from greater than or equal to about 15,000 to about 50,000 g/mol or, additionally or alternatively, from greater than or equal to about 20,000 to less than or equal to about 30,000 g/mol.

In some embodiments, the polyolefin wax utilized in the method can comprise a metallocene-catalyzed polyolefin (e.g., polypropylene) wax. In some more particular embodiments, the polyolefin wax comprises a single site metallocene-catalyzed polyolefin wax (e.g., LICOCENER 7502, a medium viscosity metallocene catalyzed polypropylene wax available from Clariant). The polyolefin wax can exhibit at least (e.g., greater than or equal to) about 10, 20, or 30 percent crystallinity, as determined, for example, by Differential Scanning calorimetry (DSC). In embodiments, the polyolefin wax has a melt temperature (T_{MELT}) of greater than or equal to about 100° C., 110° C., 120° C., 130° C., or 140° C.

In some embodiments, the polypropylene composition utilized in the method may exhibit a MFR, according to ASTM D1238, in a range of greater than or equal to from about 10 to less than or equal to about 200 dg/min, from greater than or equal to about 20 dg/min to less than or equal to about 150 dg/min, or from greater than or equal to about 50 dg/min to less than or equal to about 100 dg/min. In some embodiments, the polypropylene composition has a MFR, as determined according to ASTM D1238. For example, the polypropylene composition utilized in the method may exhibit MFR that is at least 150% greater than the MFR of the same polypropylene composition absent the polyolefin wax, additionally or alternatively, at least 100% or, additionally or alternatively, at least 50% greater, as determined according to ASTM D1238.

Additionally or alternatively, in some embodiments the polypropylene composition utilized in the method exhibits a flexural modulus that is within 50%, 40%, 30%, 20%, 15%, or 10% of the flexural modulus of the same composition absent the polyolefin wax, as measured according to ASTM D790. Additionally or alternatively, in some embodiments the polypropylene composition exhibits an Izod impact strength that is within 50%, 40%, 30%, 20%, 15%, or 10% of an Izod impact strength of the same composition absent the polyolefin wax, as measured according to ASTM D256A. Additionally or alternatively, in some embodiments the polypropylene composition exhibits a tensile yield strength, that is within 50%, 40%, 30%, 20%, 15%, or 10% percent of an tensile yield strength of the same composition absent the polyolefin wax, as measured according to ASTM D638. Additionally or alternatively, in some embodiments the polypropylene composition exhibits a tensile modulus that is within 50%, 40%, 30%, 20%, 15%, or 10% percent of a tensile modulus of the same composition absent the polyolefin wax, as measured according to ASTM D638.

In some embodiments, as noted above, the polypropylene composition utilized in the method may be characterized not having an odor and/or as having relatively little odor. For example, in embodiments, the polypropylene composition does not comprise and/or as comprising only trace amounts of byproducts such as acetone, t-butanol, acetic acid, ethyl acetate, MEK, and/or other byproducts that provide an odor to the polypropylene composition.

Also disclosed herein is a hybrid composition comprising from greater than or equal to about 10, 20, 30, 40, or 50 to about 90 weight percent (wt %) virgin polypropylene and from less than or equal to about 10 to about 90 wt % recycled polypropylene, and (e.g., the remainder, from greater than or equal to about 1 wt % to less than or equal to about 30 wt %) a polyolefin wax, wherein the hybrid composition has an improved flowability (e.g., a decreased viscosity, determined according to ASTM D7042, and/or an increased MFR, as determined according to ASTM D1238) relative to a same composition absent the polyolefin wax. In embodiments, the polypropylene base resin comprises greater than or equal to 10, 20, or 30 wt % recycled polypropylene. In embodiments, the polypropylene base resin comprises at least 10, 20, 30, 40, 50, 60, or 70 wt % virgin polypropylene. The hybrid composition can comprise from greater than or equal to about 1 to less than or equal to about 90 wt % of the virgin polypropylene and from greater than or equal to about 90 to less than or equal to about 1 wt % of the recycled polypropylene, based on a total weight of the polypropylene (e.g., a total weight of the virgin polypropylene and the recycled polypropylene).

The polypropylene base resin (e.g., the virgin polypropylene and/or recycled polypropylene) of the hybrid composition and the polyolefin wax of the hybrid composition can be as described hereinabove.

The hybrid composition may exhibit a MFR, according to ASTM D1238, in a range of from greater than or equal to about 10 dg/min to less than or equal to about 200 dg/min, from greater than or equal to about 20 dg/min to less than or equal to about 150 dg/min, or from greater than or equal to about 50 dg/min to less than or equal to about 100 dg/min. In embodiments, the hybrid composition may exhibit a MFR, as determined according to ASTM D1238, that is (e.g., at least 150, 100, or 50%) greater than a MFR, as determined according to ASTM D1238, of a same composition absent the polyolefin wax. In embodiments, the hybrid composition may exhibit: (a) a flexural modulus, as measured according to ASTM D790, that is within 50, 40, 30, 20, 15, or 10 percent of the flexural modulus of the same composition absent the polyolefin wax; (b) an Izod impact strength, as measured according to ASTM D256A, that is within 50, 40, 30, 20, 15, or 10 percent of an Izod impact strength of the same composition absent the polyolefin wax; (c) a tensile yield strength, as measured according to ASTM D638, that is within 50, 40, 30, 20, 15, or 10 percent of an tensile yield strength of the same composition absent the polyolefin wax; (d) a tensile modulus, as measured according to ASTM D638, that is within 50, 40, 30, 20, 15, or 10 percent of a tensile modulus of the same composition absent the polyolefin wax; or (e) a combination thereof.

The polypropylene (or the hybrid) composition can be a compounded composition produced by pre-mixing the polypropylene base resin(s) and the polyolefin wax and compounding via a (e.g., single or twin) extruder, or feeding the polypropylene base resin(s) separately into the (e.g., single or twin) extruder. The term “compounded” can be utilized herein to refer to melt blending materials together, optionally with additives or reinforcing agents, an can be utilized to adapt the properties of the resulting materials to specific/desired requirements.

Also disclosed herein is a product or article comprising the polypropylene composition or hybrid polypropylene composition described herein. The product can be an injection molded, sheet extruded thermoformed, or extrusion blow molded product. The polypropylene or hybrid polypropylene composition of this disclosure (e.g., pellets thereof) can be processed to make an article, such as by methods known to those of ordinary skill in the art. For example and without limitation, the pellets can be processed by injection molding, fiber extrusion, film extrusion, sheet extrusion, pipe extrusion, blow molding, rotomolding, slush molding, injection-stretch blow molding or extrusion-thermoforming to produce an article. Without limitation, the article can be, for example, a motor vehicle (e.g., automotive) component, appliance, appliance, rigid packaging, fiber, or filter media.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

Each and every claim is incorporated into the specification as an aspect of the present disclosure. Thus, the claims are a further description and are an addition to the aspects of the present invention. The discussion of a reference herein is not an admission that it is prior art to the presently disclosed subject matter, especially any reference that may have a publication date after the priority date of this application. The disclosures of all patents, patent applications, and publications cited herein are hereby incorporated by reference, to the extent that they provide exemplary, procedural or other details supplementary to those set forth herein. In the event of conflict, the present specification, including definitions, is intended to control.

To further illustrate various illustrative embodiments of the present invention, the following examples are provided.

### EXAMPLES

The disclosure having been generally described, the following Examples show particular embodiments of the disclosure. It is understood that the Examples are given by way of illustration and are not intended to limit the specification or the claims. All compositions percentages given in the examples are by weight.

Example 1. In this Example 1, a Polyolefin Wax 1 comprising Licocene-PP-7502, a polypropylene wax available from Clariant, was utilized to tailor the MFR of hybrid compounds based on a virgin polypropylene resin comprising 75 MFR reactor grade impact copolymer (5946WZ) and 30% recycled polypropylene (Banyan White 1582, a 19 MFR mixed 70/30 PCR/PIR, available from Banyan Plastics). The objective of this Example 1 was to develop a hybrid recycled polypropylene formulation with similar MFR and mechanical performance to the virgin polypropylene resin. As the recycled polypropylene (Banyan 1582) had a much lower MFR than the virgin polypropylene resin, Polyolefin Wax 1 comprising Licocene-7502 polypropylene was utilized according to this disclosure to tailor the final MFR of the hybrid polypropylene formulation.

Comparative Compound CC1 comprised (70 wt % of) the virgin polypropylene resin, 30 wt % of the recycled polypropylene resin, and no wax; Comparative Compound CC2 comprised (40 wt % of) the virgin polypropylene resin, 30 wt % of the recycled polypropylene resin, and 30 wt % of a 100 MFR polypropylene resin (3882); Inventive Compound IC1 comprised (65 wt % of) the virgin polypropylene resin, 30 wt % of the recycled polypropylene resin, and 5 wt % of the Polyolefin Wax 1 (Licocene polypropylene); Inventive Compound IC2 comprised (60 wt % of) the virgin polypropylene resin, 30 wt % of the recycled polypropylene resin, and 10 wt % of the polyolefin wax (Licocene polypropylene).

TABLE 1
Data For Example 1

| | Hybrid Compound → | | | |
|---|---|---|---|---|
| | CC1 | CC2 | IC1 | IC2 |
| Virgin | 5946WZ | 5946WZ | 5946WZ | 5946WZ |
| Polypropylene | | | | |
| Resin | | | | |
| Banyan 1582 | 30 | 30 | 30 | 30 |
| Recycled | | | | |
| Polypropylene | | | | |
| (wt %) | | | | |
| Peroxide | No | No | No | No |
| Polyolefin Wax 1 | 0 | 0 | 5 | 10 |
| (Licocene-7502 | | | | |
| Polypropylene) | | | | |
| (wt %) | | | | |
| 3882 (wt %) | 0 | 30 | 0 | 0 |

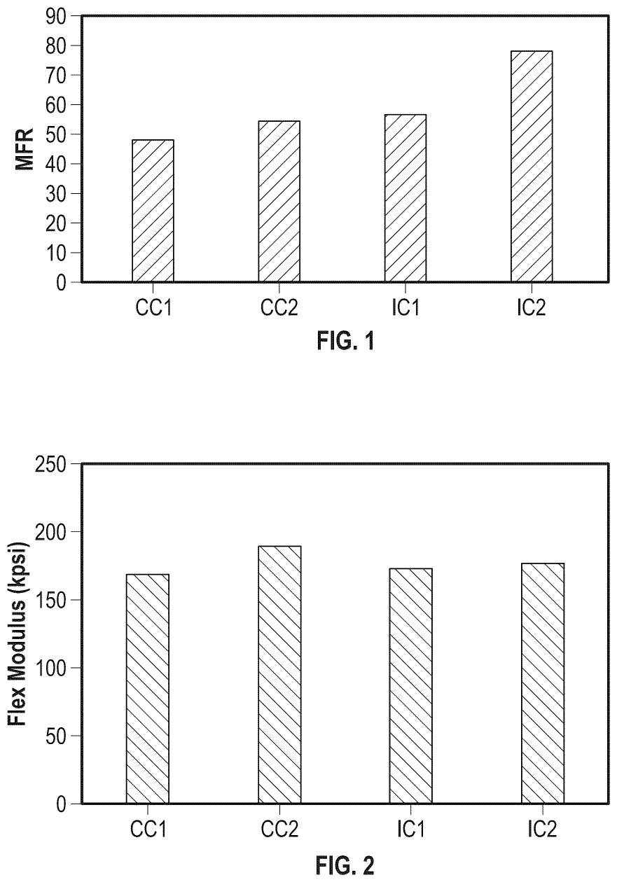

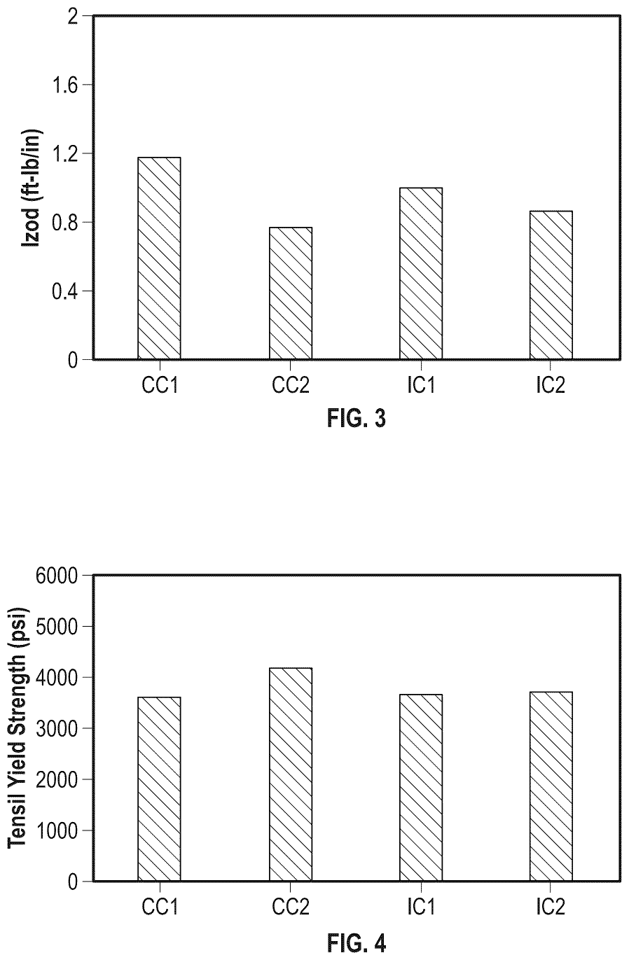

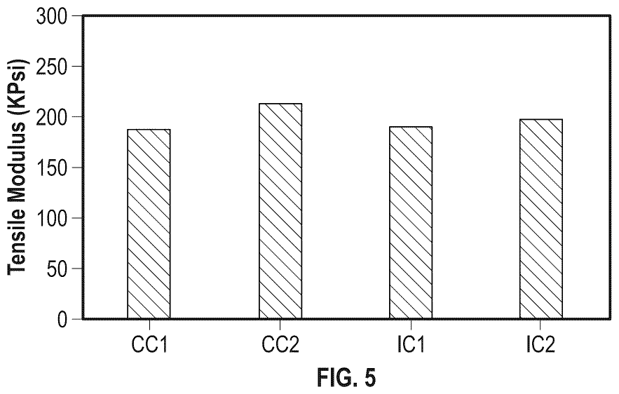

FIG. 1 is a bar graph depicting the MFR of CC1, CC2, IC1, and IC2, as determined according to ASTM D1238. FIG. 2 is a bar graph depicting the Flexural Modulus (kpsi) of CC1, CC2, IC1, and IC2, as determined according to ASTM D790. FIG. 3 is a bar graph depicting the Izod Impact (ft-lb/in) of CC1, CC2, IC1, and IC2, as determined according to ASTM D256A. FIG. 4 is a bar graph depicting the Tensile Yield Strength (psi) of CC1, CC2, IC1, and IC2, as determined according to ASTM D638. FIG. 5 is a bar graph depicting the Tensile Modulus (kpsi) of CC1, CC2, IC1, and IC2, as determined according to ASTM D638. As seen in the results shown in FIG. 1, the addition of 10% of the polyolefin wax (Licocene-PP-7502) in IC2 effectively increased the final MFR from approximately 50 (e.g., for CC1) to 80 dg/min. Furthermore, with the incorporation of 5 or 10% of the polyolefin wax (Licocene-PP-7502), the resulting polypropylene (the hybrid polypropylene compound comprising the virgin polypropylene resin and the recycled polypropylene resin) maintained desirable level of mechanical performance, including about 180 kpsi flex modulus (FIG. 2), about 0.85 ft-lbs/in Izod impact (FIG. 3), about 3800 psi tensile yield strength (FIG. 4), and about 200 kpsi tensile modulus (FIG. 5). In comparison, as seen in FIG. 1, blending a 30 wt % of the 100 MFR polypropylene resin (3882) only moderately increased the MFR of Comparative Compound CC2 relative to that of CC1. To achieve 75-80 MFR, over 70% of the 3882 had to be added, which significantly negatively affected the mechanical performance of the final products.

Example 2. In this Example 2, the cost-competitive PMSm wax or “Polyolefin Wax 2” (MW=20k-50 kDa by GPC) produced by TotalEnergies Plant Support group at La Porte Tech Center was investigated. As detailed below, three compounds were compounded with various wax level, specifically using 0% (CC3), 7% (IC4) and 15% (IC5) of the PMSm wax. Preliminary results illustrate the efficiency of the PMSm in boosting the MFR of hybrid compounds, while maintaining desirable mechanical properties. Notably, the wax-modified compounds were odor-free, which are organoleptically desirable for packaging applications.

Three hybrid compounds were compounded, comprising various amounts of the Polyolefin Wax 2. Comparative Compound CC3 comprised (70 wt % of) the virgin polypropylene resin, 30 wt % of the recycled polypropylene resin, and no wax; Inventive Compound IC3 comprised (63 wt % of) the virgin polypropylene resin, 30 wt % of the recycled polypropylene resin, and 7 wt % of the Polyolefin Wax 2 (PMSm); Inventive Compound IC4 comprised (55 wt % of) the virgin polypropylene resin, 30 wt % of the recycled polypropylene resin, and 15 wt % of the Polyolefin Wax 2 (PMSm).

TABLE 2
Data For Example 2

Hybrid Compound →

| | CC3 | IC3 | IC4 |
|---|---|---|---|
| Virgin | 5946WZ | 5946WZ | 5946WZ |
| Polypropylene | | | |
| Resin | | | |
| Banyan 1582 | 30 | 30 | 30 |
| Recycled | | | |
| Polypropylene | | | |
| (wt %) | | | |
| Peroxide | No | No | No |
| Polyolefin Wax 2 | 0 | 7 | 15 |
| (wt %) | | | |
| Licocene | No | No | No |
| Peroxide | No | No | No |
| MFR, dg/min | 45 | 54 | 84 |
| Izod, ft-lb/in | 1.07 | .97 | .7 |
| Flex Modulus, | 177 | 183 | 195 |
| kpsi | | | |
| Tensile Modulus, | 202 | 207 | 222 |
| kpsi | | | |
| Tensile Yield | 3551 | 3650 | 3811 |
| Strength, psi | | | |
| Tensile Yield | 3.9 | 3.9 | 3.7 |
| Elongation, % | | | |
| Tm (per DSC), | 163.1 | 162.7 | 162.4 |
| ° C. | | | |
| Tc (per DSC), ° C. | 121.5 | 120.9 | 120.5 |

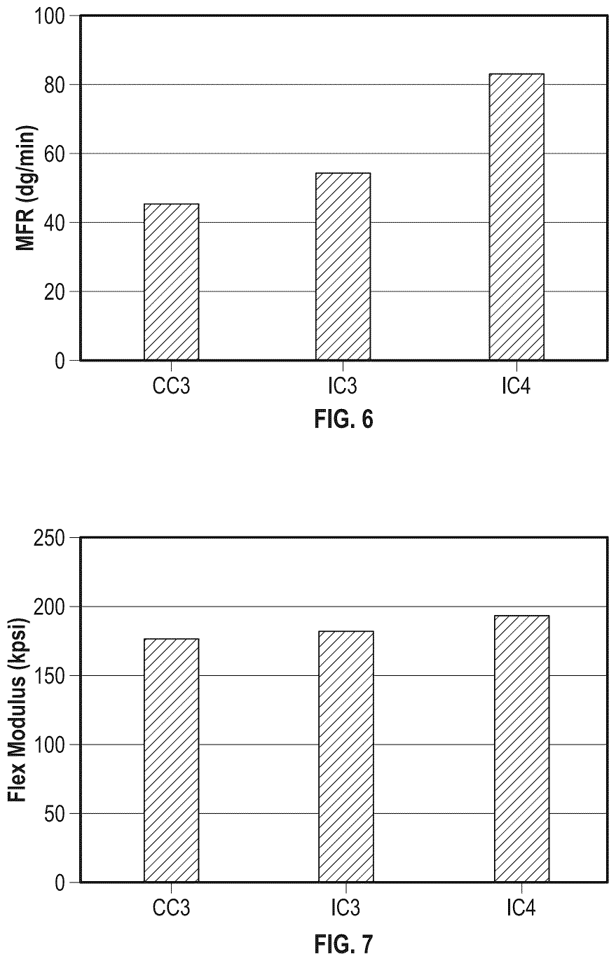

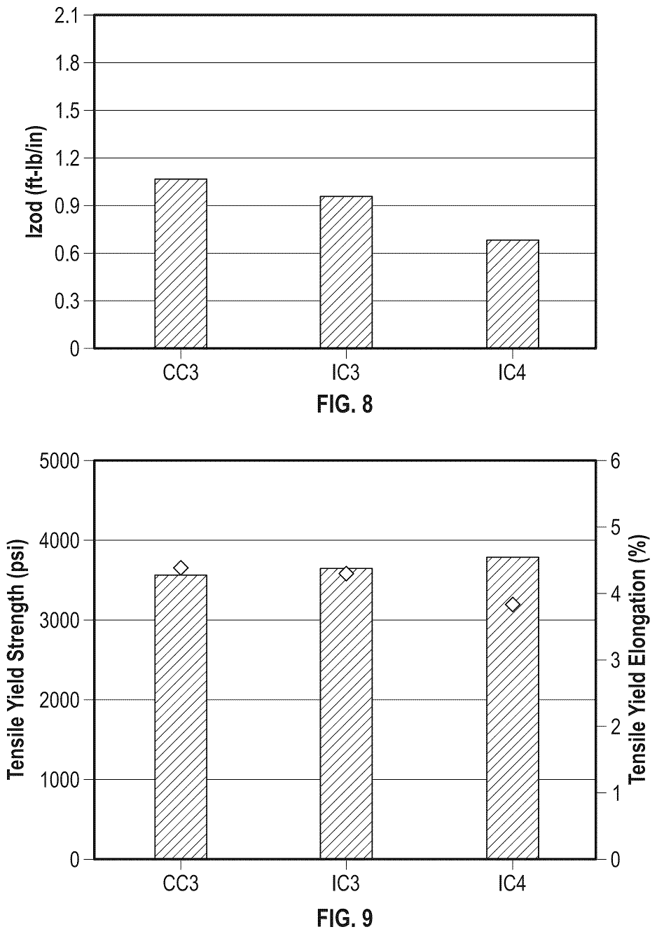

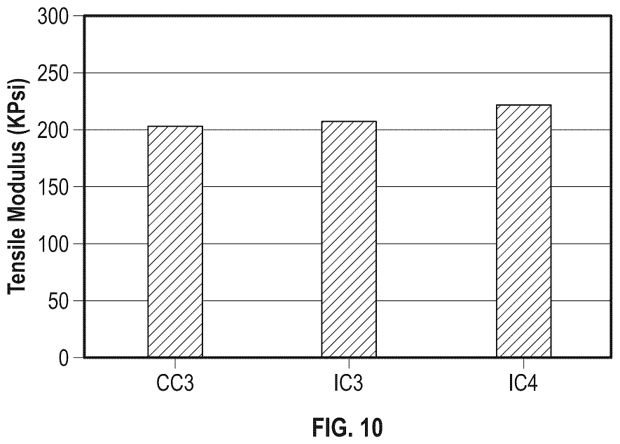

FIG. 6 is a bar graph depicting the MFR of CC3, IC3, and IC4, as determined according to ASTM D1238. FIG. 7 is a bar graph depicting the Flexural Modulus (kpsi) of CC3, IC3, and IC4, as determined according to ASTM D790. FIG. 8 is a bar graph depicting the Izod Impact (ft-lb/in) of CC3, IC3, and IC4, as determined according to ASTM D256A. FIG. 9 is a bar graph depicting the Tensile Yield Strength (psi) and Tensile Yield Elongation (%) of CC3, IC3, and IC4, as determined according to ASTM D638. FIG. 10 is a bar graph depicting the Tensile Modulus (kpsi) of CC3, IC3, and IC4, as determined according to ASTM D638. As seen in FIG. 6-FIG. 10, the inventive compounds comprising the Polyolefin Wax 2 had enhanced MFR relative to Comparative Compound CC3, while maintaining desirable mechanical properties in terms of flex modulus, Izod impact, and tensile strength. As seen in FIG. 6, inclusion of the Polyolefin Wax 2 in IC3 and IC4 efficiently boosted the MFR of IC3 and IC4 relative to the MFR of CC3, while maintaining a flexural modulus (FIG. 7), an Izod (FIG. 8), a tensile yield strength (FIG. 9), a tensile yield elongation (FIG. 9), and a tensile modulus (FIG. 10). It is noted that the wax modified compounds of this disclosure (e.g., IC1, IC2, IC3, and IC4) were odor-free compounds, which are organoleptically desirable for packaging applications.

### ADDITIONAL DISCLOSURE

The following are non-limiting, specific embodiments in accordance with the present disclosure:

In a first embodiment, a polypropylene composition comprises: a polypropylene base resin; and a polyolefin wax, wherein the polypropylene 20 composition comprises from about 1 to about 20, from about 5 to about 15 or from about 10 to about 15 weight percent (wt %) of the polyolefin wax, based on a total weight of the polypropylene composition.

A second embodiment can include the polypropylene composition of the first embodiment, wherein the polypropylene base resin comprises virgin polypropylene, recycled polypropylene, or a combination thereof.

A third embodiment can include the polypropylene composition of the second embodiment, wherein the polypropylene base resin is a hybrid resin comprising virgin polypropylene and recycled polypropylene.

A fourth embodiment can include the polypropylene composition of the third embodiment, wherein the hybrid resin comprises from about 1 to about 90 weight percent (wt %) of the virgin polypropylene and from about 90 to about 1 weight percent (wt %) of the recycled polypropylene, based on a total weight of the hybrid resin.

A fifth embodiment can include the polypropylene composition of any one of the first to fourth embodiments, wherein the polypropylene base resin comprises a homopolymer, a copolymer, an impact copolymer, or a combination thereof.

A sixth embodiment can include the polypropylene composition of any one of the first to fifth embodiments, wherein the polypropylene base resin comprises a Ziegler-Natta catalyzed polypropylene, a metallocene catalyzed polypropylene, or a combination thereof.

A seventh embodiment can include the polypropylene composition of any one of the first to sixth embodiments, wherein the polypropylene base resin has a melt flow rate (MFR), according to ASTM D1238 in a range of from about 0.5 dg/min to about 200 dg/min, from about 20 dg/min to about 150 dg/min, or from about 50 dg/min to about 100 dg/min.

An eighth embodiment can include the polypropylene composition of any one of the first to seventh embodiments, wherein the polypropylene base resin is a reactor grade polypropylene or a vis-broken grade polypropylene.

A ninth embodiment can include the polypropylene composition of any one of the first to eighth embodiments, wherein the polyolefin wax comprises a polypropylene wax, a polyethylene wax, a copolymer wax (e.g., a polypropylene/polyethylene copolymer wax), or a combination thereof.

A tenth embodiment can include the polypropylene composition of any one of the first to ninth embodiments, wherein the polyolefin wax is a product of (e.g., producing the polyolefin wax from) petroleum based, recycled resources (e.g., recycled plastics), renewable resource(s), or a combination thereof.

An eleventh embodiment can include the polypropylene composition of the tenth embodiment, wherein the renewable resource comprises a (e.g., Braskem) renewable resource polyethylene wax, a hydrogenated vegetable oil wax, or a combination thereof.

A twelfth embodiment can include the polypropylene composition of any one of the first to eleventh embodiments, wherein the polyolefin wax has a viscosity in a range of from about 500 to about 50,000 MPa·s, from about 1000 to about 20000 MPa·s, or from about 1000 to about 3000 MPa·s, as measured according to ASTM D 7042.

A thirteenth embodiment can include the polypropylene composition of any one of the first to twelfth embodiments, wherein the polyolefin wax comprises a polypropylene wax.

A fourteenth embodiment can include the polypropylene composition of the thirteenth embodiment, wherein the polypropylene wax has a weight average molecular weight (MW) in a range of from about 10,000 to about 100,000 g/mol, from about 15,000 to about 50,000 g/mol, or from about 20,000 to about 30,000 g/mol.

A fifteenth embodiment can include the polypropylene composition of any one of the first to fourteenth embodiments, wherein the polyolefin wax has a weight average molecular weight (MW) in a range of from about 10,000 to about 100,000 g/mol, from about 15,000 to about 50,000 g/mol, or from about 20,000 to about 30,000 g/mol.

A sixteenth embodiment can include the polypropylene composition of any one of the first to fifteenth embodiments, wherein the polyolefin wax comprises a metallocene catalyzed polypropylene wax.

A seventeenth embodiment can include the polypropylene composition of the sixteenth embodiment, wherein the polyolefin wax comprises a single site metallocene catalyzed polyolefin wax (e.g., LICOCENE® 7502, available from Clariant).

An eighteenth embodiment can include the polypropylene composition of any one of the first to seventeenth embodiments, wherein the polyolefin wax exhibits at least (e.g., greater than or equal to) about 10, 20, or 30 percent crystallinity, as determined by Differential Scanning calorimetry (DSC).

A nineteenth embodiment can include the polypropylene composition of any one of the first to eighteenth embodiments, wherein the polyolefin wax has a melt temperature (T_{MELT}) of greater than or equal to about 100° C., 110° C., 120° C., 130° C., or 140° C.

A twentieth embodiment can include the polypropylene composition of any one of the first to nineteenth embodiments, having a melt flow rate (MFR), according to ASTM D1238, in a range of from about 10 to about 200, from about 20 to about 150, or from about 50 to about 100 grams (g)/10 minutes (min).

A twenty first embodiment can include the polypropylene composition of any one of the first to twentieth embodiments, wherein the polypropylene composition has a melt flow rate (MFR), as determined according to ASTM D1238, that is (e.g., at least 150, 100, or 50%) greater than a melt flow rate, as determined according to ASTM D1238, of a same polypropylene composition absent the polyolefin wax.

A twenty second embodiment can include the polypropylene composition of the twenty first embodiment, wherein the polypropylene composition has: (a) a flexural modulus, as measured according to ASTM D790, that is within 50, 40, 30, 20, 15, or 10 percent of the flexural modulus of the same composition absent the polyolefin wax; (b) an Izod impact strength, as measured according to ASTM D256A, that is within 50, 40, 30, 20, 15, or 10 percent of an Izod impact strength of the same composition absent the polyolefin wax; (c) a tensile yield strength, as measured according to ASTM D638, that is within 50, 40, 30, 20, 15, or 10 percent of an tensile yield strength of the same composition absent the polyolefin wax; (d) a tensile modulus, as measured according to ASTM D638, that is within 50, 40, 30, 20, 15, or 10 percent of a tensile modulus of the same composition absent the polyolefin wax; or (e) a combination thereof.

A twenty third embodiment can include the polypropylene composition of any one of the first to twenty second embodiments, comprising a weight ratio of the polypropylene base resin to the polyolefin wax in a range of from about 1 to about 20, from about 5 to about 15, or from about 10 to about 15.

In a twenty fourth embodiment, a method of increasing a flowability (e.g., controlling rheology) of a polypropylene base resin comprises: combining the polypropylene base resin with a polyolefin wax to provide a polypropylene composition having the increased flowability (e.g., an increased melt flow rate (MFR), determined according to ASTM D1238, and/or a decreased viscosity, determined according to ASTM D7042) relative to that of the polypropylene base resin.

A twenty fifth embodiment can include the method of the twenty fourth embodiment, wherein combining comprises extruding the polypropylene base resin with (e.g., granules of) the polyolefin wax to provide the polypropylene composition.

A twenty sixth embodiment can include the method of the twenty fourth or twenty fifth embodiment, wherein the polypropylene base resin comprises virgin polypropylene, recycled polypropylene, or a combination thereof.

A twenty seventh embodiment can include the method of the twenty sixth embodiment, wherein the polypropylene base resin is a hybrid resin comprising virgin polypropylene and recycled polypropylene.

A twenty eighth embodiment can include the method of the twenty seventh embodiment, wherein the hybrid resin comprises from about 1 to about 90 weight percent (wt %) of the virgin polypropylene and from about 90 to about 1 weight percent (wt %) of the recycled polypropylene, based on a total weight of the hybrid resin.

A twenty ninth embodiment can include the method of any one of the twenty fourth to twenty eighth embodiments, wherein the polypropylene base resin comprises a homopolymer, a copolymer, an impact copolymer, or a combination thereof.

A thirtieth embodiment can include the method of any one of the twenty fourth to twenty ninth embodiments, wherein the polypropylene base resin comprises a Ziegler-Natta catalyzed polypropylene, a metallocene catalyzed polypropylene, or a combination thereof.

A thirty first embodiment can include the method of any one of the twenty fourth to thirtieth embodiments, wherein the polypropylene base resin has a melt flow rate (MFR), according to ASTM D1238 in a range of from about 0.5 dg/min to about 200 dg/min, from about 20 dg/min to about 150 dg/min, or from about 50 dg/min to about 100 dg/min.

A thirty second embodiment can include the method of any one of the twenty fourth to thirty first embodiments, wherein the polypropylene base resin is a reactor grade polypropylene or a vis-broken grade polypropylene.

A thirty third embodiment can include the method of any one of the twenty fourth to thirty second embodiments, wherein the polyolefin wax comprises a polypropylene wax, a polyethylene wax, a copolymer wax (e.g., a polypropylene/polyethylene copolymer wax), or a combination thereof.

A thirty fourth embodiment can include the method of any one of the twenty fourth to thirty third embodiments, wherein the polyolefin wax is a product of (e.g., producing the polyolefin wax from) petroleum based, recycled resources (e.g., recycled plastics), renewable resource(s), or a combination thereof.

A thirty fifth embodiment can include the method of the thirty fourth embodiment, wherein the renewable resource comprises a (e.g., Braskem) renewable resource polyethylene wax, a hydrogenated vegetable oil wax, or a combination thereof.

A thirty sixth embodiment can include the method of any one of the twenty fourth to thirty fifth embodiments, wherein the polyolefin wax has a viscosity in a range of from about 500 to about 50,000 MPa·s, from about 1000 to about 20000 MPa·s, or from about 1000 to about 3000 MPa·s, as measured according to ASTM D 7042.

A thirty seventh embodiment can include the method of any one of the twenty fourth to thirty sixth embodiments, wherein the polyolefin wax comprises: a polypropylene wax.

A thirty eighth embodiment can include the method of the thirty seventh embodiment, wherein the polypropylene wax has a weight average molecular weight (MW) in a range of from about 10,000 to about 100,000 g/mol, from about 15,000 to about 50,000 g/mol, or from about 20,000 to about 30,000 g/mol.

A thirty ninth embodiment can include the method of any one of the twenty fourth to thirty eighth embodiments, wherein the polyolefin wax has a weight average molecular weight (MW) in a range of from about 10,000 to about 100,000 g/mol, from about 15,000 to about 50,000 g/mol, or from about 20,000 to about 30,000 g/mol.

A fortieth embodiment can include the method of any one of the twenty fourth to thirty ninth embodiments, wherein the polyolefin wax comprises a metallocene catalyzed polypropylene wax.

A forty first embodiment can include the method of the fortieth embodiment, wherein the polyolefin wax comprises a single site metallocene catalyzed polyolefin wax (e.g., LICOCENE® 7502, available from Clariant).

A forty second embodiment can include the method of any one of the twenty fourth to forty first embodiments, wherein the polyolefin wax exhibits at least (e.g., greater than or equal to) about 10, 20, or 30 percent crystallinity, as determined by Differential Scanning calorimetry (DSC).

A forty third embodiment can include the method of any one of the twenty fourth to forty second embodiments, wherein the polyolefin wax has a melt temperature (T_{MELT}) of greater than or equal to about 100° C., 110° C., 120° C., 130° C., or 140° C.

A forty fourth embodiment can include the method of any one of the twenty fourth to forty third embodiments, wherein the polypropylene composition has a melt flow rate (MFR), according to ASTM D1238, in a range of from about 10 to about 200, from about 20 to about 150, or from about 50 to about 100 grams (g)/10 minutes (min).

A forty fifth embodiment can include the method of any one of the twenty fourth to forty fourth embodiments, wherein the polypropylene composition has a melt flow rate (MFR), as determined according to ASTM D1238, that is (e.g., at least 150, 100, or 50%) greater than a melt flow rate, as determined according to ASTM D1238, of a same polypropylene composition absent the polyolefin wax.

A forty sixth embodiment can include the method of the forty fifth embodiment, wherein the polypropylene composition has: (a) a flexural modulus, as measured according to ASTM D790, that is within 50, 40, 30, 20, 15, or 10% percent of the flexural modulus of the same composition absent the polyolefin wax; (b) an Izod impact strength, as measured according to ASTM D256A, that is within 50, 40, 30, 20, 15, or 10% percent of an Izod impact strength of the same composition absent the polyolefin wax; (c) a tensile yield strength, as measured according to ASTM D638, that is within 50, 40, 30, 20, 15, or 10% percent of an tensile yield strength of the same composition absent the polyolefin wax; (d) a tensile modulus, as measured according to ASTM D638, that is within 50, 40, 30, 20, 15, or 10% percent of a tensile modulus of the same composition absent the polyolefin wax; or (e) a combination thereof.

A forty seventh embodiment can include the method of any one of the twenty fourth to forty sixth embodiments, wherein the polypropylene composition comprises a weight ratio of the polypropylene base resin to the polyolefin wax in a range of from about 1 to about 20, from about 5 to about 15, or from about 10 to about 15.

In a forty eighth embodiment, a hybrid composition comprises: from about 50 to about 90 weight percent (wt %) virgin polypropylene and from about 10 to about 50 wt % recycled polypropylene, and a polyolefin wax, wherein the hybrid composition has an improved flowability (e.g., a decreased viscosity, determined according to ASTM D7042, and/or an increased melt flow rate (MFR), as determined according to ASTM D1238) relative to a same composition absent the polyolefin wax.

A forty ninth embodiment can include the hybrid composition of the forty eighth embodiment, wherein the polypropylene base resin comprises at least 10, 20, or 30 wt % recycled polypropylene.

A fiftieth embodiment can include the hybrid composition of the forty ninth embodiment, wherein the polypropylene base resin comprises at least 10, 20, or 30 wt % virgin polypropylene.

A fifty first embodiment can include the hybrid composition of the forty ninth or fiftieth embodiment, wherein the hybrid composition comprises from about 1 to about 90 weight percent (wt %) of the virgin polypropylene and from about 90 to about 1 weight percent (wt %) of the recycled polypropylene, based on a total weight of the polypropylene.

A fifty second embodiment can include the hybrid composition of any one of the forty eighth to fifty first embodiments, wherein the polypropylene base resin comprises a homopolymer, a copolymer, an impact copolymer, or a combination thereof.

A fifty third embodiment can include the hybrid composition of any one of the forty eighth to fifty second embodiments, wherein the polypropylene base resin comprises a Ziegler-Natta catalyzed polypropylene, a metallocene catalyzed polypropylene, or a combination thereof.

A fifty fourth embodiment can include the hybrid composition of any one of the forty eighth to fifty third embodiments, wherein the polypropylene base resin has a melt flow rate (MFR), according to ASTM D1238 in a range of from about 0.5 grams (g)/10 minutes (min) to about 200 dg/min, from about 20 dg/min to about 150 dg/min, or from about 50 dg/min to about 100 dg/min.

A fifty fifth embodiment can include the hybrid composition of any one of the forty eighth to fifty fourth embodiments, wherein the polypropylene base resin is a reactor grade polypropylene or a vis-broken grade polypropylene.

A fifty sixth embodiment can include the hybrid composition of any one of the forty eighth to fifty fifth embodiments, wherein the polyolefin wax comprises a polypropylene wax, a polyethylene wax, a copolymer wax (e.g., a polypropylene/polyethylene copolymer wax), or a combination thereof.

A fifty seventh embodiment can include the hybrid composition of any one of the forty eighth to fifty sixth embodiments, wherein the polyolefin wax is a product of (e.g., producing the polyolefin wax from) petroleum based, recycled resources (e.g., recycled plastics), renewable resource(s), or a combination thereof.

A fifty eighth embodiment can include the hybrid composition of the fifty seventh embodiment, wherein the renewable resource comprises a (e.g., Braskem) renewable resource polyethylene wax, a hydrogenated vegetable oil wax, or a combination thereof.

A fifty ninth embodiment can include the hybrid composition of any one of the forty eighth to fifty eighth embodiments, wherein the polyolefin wax has a viscosity in a range of from about 500 to about 50,000 MPa·s, from about 1000 to about 20000 MPa·s, or from about 1000 to about 3000 MPa·s, as measured according to ASTM D 7042.

A sixtieth embodiment can include the hybrid composition of any one of the forty eighth to fifty ninth embodiments, wherein the polyolefin wax comprises: a polypropylene wax.

A sixty first embodiment can include the hybrid composition of the sixtieth embodiment, wherein the polypropylene wax has a weight average molecular weight (Mw) in a range of from about 10,000 to about 100,000 g/mol, from about 15,000 to about 50,000 g/mol, or from about 20,000 to about 30,000 g/mol.

A sixty second embodiment can include the hybrid composition of any one of the forty eighth to sixty first embodiments, wherein the polyolefin wax has a weight average molecular weight (MW) in a range of from about 10,000 to about 100,000 g/mol, from about 15,000 to about 50,000 g/mol, or from about 20,000 to about 30,000 g/mol.

A sixty third embodiment can include the hybrid composition of any one of the forty eighth to sixty second embodiments, wherein the polyolefin wax comprises a metallocene catalyzed polypropylene wax.

A sixty fourth embodiment can include the hybrid composition of the sixty third embodiment, wherein the polyolefin wax comprises a single site metallocene catalyzed polyolefin wax (e.g., LICOCENE® 7502, available from Clariant).

A sixty fifth embodiment can include the hybrid composition of any one of the forty eighth to sixty fourth embodiments, wherein the polyolefin wax exhibits at least (e.g., greater than or equal to) about 10, 20, or 30 percent crystallinity, as determined by Differential Scanning calorimetry (DSC).

A sixty sixth embodiment can include the hybrid composition of any one of the forty eighth to sixty fifth embodiments, wherein the polyolefin wax has a melt temperature (T_{MELT}) of greater than or equal to about 100° C., 110° C., 120° C., 130° C., or 140° C.

A sixty seventh embodiment can include the hybrid composition of any one of the forty eighth to sixty sixth embodiments, having a melt flow rate (MFR), according to ASTM D1238, in a range of from about 10 to about 200, from about 20 to about 150, or from about 50 to about 100 grams (g)/10 minutes (min).

A sixty eighth embodiment can include the hybrid composition of any one of the forty eighth to sixty seventh embodiments, wherein the hybrid composition has a melt flow rate (MFR), as determined according to ASTM D1238, that is (e.g., at least 150, 100, or 50%) greater than a melt flow rate, as determined according to ASTM D1238, of a same composition absent the polyolefin wax.

A sixty ninth embodiment can include the hybrid composition of the sixty eighth embodiment, wherein the hybrid composition has: (a) a flexural modulus, as measured according to ASTM D790, that is within 50, 40, 30, 20, 15, or 10 percent of the flexural modulus of the same composition absent the polyolefin wax; (b) an Izod impact strength, as measured according to ASTM D256A, that is within 50, 40, 30, 20, 15, or 10 percent of an Izod impact strength of the same composition absent the polyolefin wax; (c) a tensile yield strength, as measured according to ASTM D638, that is within 50, 40, 30, 20, 15, or 10 percent of an tensile yield strength of the same composition absent the polyolefin wax; (d) a tensile modulus, as measured according to ASTM D638, that is within 50, 40, 30, 20, 15, or 10 percent of a tensile modulus of the same composition absent the polyolefin wax; or (e) a combination thereof.

A seventieth embodiment can include the hybrid composition of any one of the forty eighth to sixty ninth embodiments, comprising a weight ratio of the polypropylene base resin to the polyolefin wax in a range of from about 1 to about 20, from about 5 to about 15, or from about 10 to about 15.

What is claimed is:

1. A polypropylene composition, comprising:
a polypropylene base resin; and
a polyolefin wax;
wherein the polypropylene composition comprises the polyolefin wax in an amount ranging from greater than or equal to about 1 weight percent (wt %) to less than or equal to about 20 wt %, based on a total weight of the polypropylene composition.

2. The polypropylene composition of claim 1, wherein the polypropylene base resin is a hybrid resin comprising virgin polypropylene and recycled polypropylene.

3. The polypropylene composition of claim 1, wherein the polyolefin wax has a viscosity in a range of from about 500 to about 50,000 MPa·s, as measured according to ASTM D 7042.

4. The polypropylene composition of claim 1, wherein the polyolefin wax comprises a polypropylene wax having a weight average molecular weight (Mw) in a range of from about 10,000 to about 100,000 g/mol.

5. The polypropylene composition of claim 1, wherein the polyolefin wax has a weight average molecular weight (Mw) in a range of from about 10,000 to about 100,000 g/mol.

6. The polypropylene composition of claim 1, wherein the polyolefin wax exhibits greater than or equal to about 10 percent crystallinity, as determined by Differential Scanning calorimetry (DSC).

7. The polypropylene composition of claim 1, wherein the polyolefin wax has a melt temperature (T_{MELT}) of greater than or equal to about 100° C.

8. The polypropylene composition of claim 1, wherein the polypropylene composition has a melt flow rate, as determined according to ASTM D1238, that greater than a melt flow rate, as determined according to ASTM D1238, of a same polypropylene composition absent the polyolefin wax.

9. The polypropylene composition of claim 8, wherein the polypropylene composition has:
(a) a flexural modulus, as measured according to ASTM D790, that is within 20 percent of the flexural modulus of the same composition absent the polyolefin wax;
(b) an Izod impact strength, as measured according to ASTM D256A, that is within 20 percent of an Izod impact strength of the same composition absent the polyolefin wax;
(c) a tensile yield strength, as measured according to ASTM D638, that is within 20 percent of an tensile yield strength of the same composition absent the polyolefin wax;
(d) a tensile modulus, as measured according to ASTM D638, that is within 20 percent of a tensile modulus of the same composition absent the polyolefin wax; or
(e) a combination thereof.

10. A method of increasing a flowability of a polypropylene base resin, the method comprising:
combining the polypropylene base resin with a polyolefin wax to provide a polypropylene composition having the increased flowability, as determined by an increased melt flow rate, determined according to ASTM D1238, and/or a decreased viscosity, determined according to ASTM D7042, relative to that of the polypropylene base resin.

11. The method of claim 10, wherein combining comprises extruding the polypropylene base resin with the polyolefin wax to provide the polypropylene composition.

12. The method of claim 10, wherein the polypropylene base resin is a hybrid resin comprising virgin polypropylene and recycled polypropylene.

13. The method of claim 10, wherein the polyolefin wax has a viscosity in a range of from about 500 to about 50,000 MPa·s, as measured according to ASTM D 7042.

14. The method of claim 10, wherein the polyolefin wax has a weight average molecular weight (Mw) in a range of from about 10,000 to about 100,000 g/mol.

15. The method of claim 10, wherein the polypropylene composition has a melt flow rate, as determined according to ASTM D1238, that is greater than a melt flow rate, as determined according to ASTM D1238, of a same polypropylene composition absent the polyolefin wax.

16. A hybrid composition, comprising:
a polyolefin wax;
virgin polypropylene; and
recycled polypropylene;
wherein the hybrid composition comprises the virgin polypropylene in an amount ranging from greater than or equal to about 50 weight percent (wt %) to less than or equal to about 90 wt %, and the recycled polypropylene in an amount ranging from greater than or equal to about 10 wt % to less than or equal to about 50 wt %, based on a total weight of the virgin and recycled polypropylene; and
wherein the hybrid composition has an improved flowability as measured by a decreased viscosity, determined according to ASTM D7042, and/or an increased melt flow rate, as determined according to ASTM D1238, relative to a same composition absent the polyolefin wax.

17. The hybrid composition of claim 16, wherein the polypropylene base resin has a melt flow rate, according to ASTM D1238 in a range of from about 0.5 decigrams (dg)/minute (min) to about 200 dg/min.

18. The hybrid composition of claim 16, wherein the polyolefin wax has a viscosity in a range of from about 500 to about 50,000 MPa·s, as measured according to ASTM D 7042.

19. The hybrid composition of claim 16, wherein the polyolefin wax has a weight average molecular weight (Mw) in a range of from about 10,000 to about 100,000 g/mol.

20. The hybrid composition of claim 16, wherein the hybrid composition has a melt flow rate, as determined according to ASTM D1238, that is greater than a melt flow rate, as determined according to ASTM D1238, of a same composition absent the polyolefin wax.
